(19) United States
(12) Patent Application Publication
(10) Pub. No.: US 2014/0272174 A1
(43) Pub. Date: Sep. 18, 2014

(54) PATTERN FORMATION METHOD AND PATTERN FORMATION DEVICE

(71) Applicant: KABUSHIKI KAISHA TOSHIBA, Tokyo (JP)

(72) Inventor: Yohko FURUTONO, Kanagawa-ken (JP)

(73) Assignee: KABUSHIKI KAISHA TOSHIBA, Tokyo (JP)

(21) Appl. No.: 13/966,596

(22) Filed: Aug. 14, 2013

(30) Foreign Application Priority Data
Mar. 15, 2013 (JP) 2013-053634

(51) Int. Cl. B05D 3/12; B05C 9/12

(52) U.S. Cl. CPC B05D 3/12; B05C 9/12
USPC 427/487; 427/277; 118/696

(57) ABSTRACT

According to one embodiment, a pattern formation method is disclosed. The method includes preparing a substrate having an underlying pattern and a mold having a concave/convex pattern. The method cures the resin in an uncured region and separate the mold from the resin. The curing the resin includes first and second curing processes. When the uncured region is provided in a plurality, the first process includes performing position alignment of the mold with reference to the substrate, determining a positional displacement amount of the concave/convex pattern with reference to the underlying pattern, and curing the resin in the uncured region having the smallest positional displacement amount. The performing, the determining and the curing are repeated until the uncured regions are reduced to one. When the uncured region is one, the second process includes performing position alignment of the mold with reference to the substrate, and curing the resin.

### CROSS-REFERENCE TO RELATED APPLICATIONS

This application is based upon and claims the benefit of priority from Japanese Patent Application No. 2013-053634, filed on Mar. 15, 2013; the entire contents of which are incorporated herein by reference.

### FIELD

Embodiments described herein relate generally to a pattern formation method and a pattern formation device.

### BACKGROUND

There exists, for example, an imprint method as a pattern formation method forming a pattern such as a semiconductor device. The imprint method is a method transferring a shape of a concave/convex pattern provided on a mold (original plate) to an object, and attracts attention as a technique satisfying both of formation of a fine pattern with not more than 100 nanometers (nm) and mass productivity. In the imprint method, for example, a photo-curing resin is applied on a substrate on which the pattern shape is transferred, and the concave-convex pattern of the mold is contacted the resin. In this state, the resin is irradiated with a light to be cured, and then the mold is separated from the resin. This causes the shape of the concave-convex pattern of the mold is transferred to the resin. In the pattern formation method, it is important to improve accuracy of alignment of the mold and the substrate.

### BRIEF DESCRIPTION OF THE DRAWINGS

FIG. 1 and FIG. 2 are flow charts illustrating a pattern formation method according to a first embodiment;

FIG. 3 is a schematic plan view illustrating a specific example (I);

FIG. 4A to FIG. 4D are schematic cross-sectional views illustrating the pattern formation method the specific example (I),

FIG. 5A to FIG. 5E are schematic cross-sectional views illustrating the specific example (II);

FIG. 6 and FIG. 7 are flow charts illustrating a pattern formation method according to a second embodiment;

FIG. 8A to FIG. 8E are schematic plan views illustrating the specific example (III);

FIG. 9A and FIG. 9B are schematic plan views illustrating an order of resin curing;

FIG. 10A and FIG. 10B are schematic plan views illustrating irradiation area of light;

FIG. 11A to FIG. 12B are schematic plan views illustrating a direction in which the resin is cured;

FIG. 13 is a schematic view illustrating the configuration of a pattern formation apparatus according to a third embodiment; and

FIG. 14 illustrates the hard ware configuration of a computer.

### DETAILED DESCRIPTION

According to one embodiment, a pattern formation method is disclosed. The method can include preparing a substrate having an underlying pattern and applying a resin to the substrate, and preparing a mold having a concave/convex pattern, interposing the mold on the substrate, and causing the concave/convex pattern to contact the resin. The method can cure the resin in an uncured region where the resin is uncured, the uncured region being one of a plurality of regions into which the resin is divided. The method can separate the mold from the resin. The curing the resin in the uncured region includes a first curing process and a second curing process. When the uncured region is provided in a plurality, the first curing process includes performing position alignment of the mold with reference to the substrate, determining a positional displacement amount of the concave/convex pattern with reference to the underlying pattern for each of the plurality of uncured regions, and curing the resin in the uncured region having a smallest positional displacement amount in the plurality of uncured regions. The performing, the determining and the curing are repeated until the uncured regions are reduced to one. When the uncured region is one, the second curing process includes performing position alignment of the mold with reference to the substrate, and curing the resin in the uncured region.

### First Embodiment

FIG. 1 and FIG. 2 are flow charts illustrating a pattern formation method according to a first embodiment.

FIG. 1 shows the whole flow of the pattern formation method according to the first embodiment, and FIG. 2 shows the flow of a part of processes shown in FIG. 1.

As shown in FIG. 1, the pattern formation method according to the first embodiment includes a process of preparing a substrate (step S101), a process of applying a resin (step S102), a process of contacting the mold to the resin (step S103), a process of curing the resin (step S104), and a process of separating the mold from the resin (step S105).

The substrate prepared in the step S101 has a major surface and an underlying pattern provided on the major surface. In the step S102, the resin is applied onto the major surface of the substrate. The resin is, for example, a photo-curing resin cured by light irradiation.

In the step S103, first, the mold having the concave/convex pattern is prepared. The concave/convex pattern has a reversed concave/convex shape of the pattern shape to be transferred to the resin. Next, the mold is superimposed on the substrate. The superimposed direction is a direction (Z-direction) perpendicular to the major surface of the substrate. At this time, the major surface of the substrate faces the concave/convex pattern. Next, the concave/convex pattern of the mold is caused to contact the resin applied onto the major surface of the substrate.

In the step S104, when the resin is divided into a plurality of regions, resins in uncured regions of the plurality of regions are cured. Here, dividing the resin means dividing the resin into the plurality of regions as viewed in the Z-direction.

In the step S105, the mold is separated from the cured resin. This transfers the shape of the concave/convex pattern of the mold to the resin. The reversed pattern of the concave/convex shape of the concave/convex pattern is formed on the resin. In the pattern formation method according to the embodiment, the object on which the pattern is formed is the resin and the substrate (including a film formed on the substrate). In order to form the pattern on the substrate, after forming the pattern on the resin as described previously, the substrate is etched using the resin as a mask. This causes the resin pattern to be transferred to the substrate.

In the pattern formation method according to the first embodiment, the resins of the uncured regions are cured along the flow chart shown in FIG. 2 as a process causing the resin shown in the step S104 to be cured.

As shown in FIG. 2, first, in the step S141, it is determined whether or not there exists a plurality of uncured regions. When there exist the plurality of uncured regions, processes in the step S142 to the step S144 are performed. The processes in the step S142 to the step S144 constitute a first curing process. On the other hand, when there exist no plurality of uncured regions, namely, in the case of one uncured region, processes in the step S145 to the step S146 are performed. The processes in the step S145 to the step S146 constitute a second curing process.

First, the first curing process will be described. In the step S142, the position alignment of the mold is performed using the substrate as a reference. For example, for each of the plurality of uncured regions, the position alignment of the underlying pattern provided on the substrate and the concave/convex pattern of the mold is performed. The underlying patter includes a first alignment mark. The concave/convex pattern includes a second alignment mark. In the step S142, for example, for each of the plurality of uncured regions, the position alignment of the substrate and the mold is performed so that the first alignment mark and the second alignment mark superimpose in the Z-direction. In order to perform the position alignment, when setting the plurality of regions, it is desired that the first alignment mark and the second alignment mark are included in each region as viewed in the Z-direction.

Here, the position alignment of the mold as referenced to the substrate is performed by moving at least one of a stage holding the substrate and a chuck holding the mold. More accurate position alignment is performed by pushing a periphery of the mold and controlling an outline size of the mold.

Next, in the step S143, the amount of positional displacement of the concave/convex pattern as referenced to the underlying pattern is evaluated for each of the plurality of uncured regions. For example, the amount of positional displacement of the second alignment mark as referenced to the first alignment mark is evaluated for each of the plurality of uncured regions. The amount of the positional displacement is evaluated from, for example, a displacement amount (dx) in the X-direction orthogonal to the Z-direction, a displacement amount (dy) in the Y-direction orthogonal to the Z-direction and the X-direction, and a displacement amount (de) in a rotational direction along the XY plane.

Next, in the step S144, the resin in the uncured region with the smallest displacement amount of the plurality of uncured regions is cured. First, the uncured region with the smallest positional displacement amount is selected from each positional displacement amount of the plurality of uncured regions evaluated in the step S143.

The positional displacement amount used for the selection is, for example, a distance evaluated from the displacement amount (dx) in the X-direction and the displacement amount (dy) in the Y-direction. Other than the distance, the displacement amount of one of the displacement amount (dx) in the X-direction, the displacement amount (dy) in the Y-direction and the displacement amount (dθ) in the rotational direction, and the comprehensive displacement amount calculated from the displacement amount (dx) in the X-direction, the displacement amount (dy) in the Y-direction and the displacement amount (dθ) in the rotational direction may be used. Here, the selection object is uncured region having the positional displacement amount not more than a reference value previously set.

Next, the resin in the selected uncured region is cured. That is, the resin in the selected uncured region is irradiated with light to be cured.

The first curing process in the step S142 to the step 144 is repeated until the number of the uncured regions decreases to one. When the number of the uncured region is one left, the second curing process is performed.

Next, the second curing process will be described. In the step S145, the position alignment of the mold is performed using the substrate as a reference. In the step S145, the position alignment of the underlying pattern provided on the substrate and the concave/convex pattern of the mold is performed for one uncured region left. For example, the position alignment of the substrate and the mold is performed for the one uncured region so that the first alignment mark and the second alignment mark superimpose in the Z-direction.

Next, in the step S146, the resin in one uncured region left is cured. That is, in the position alignment in the step S145, the resin in the uncured region is cured when the displacement amount of the one uncured region left is equal to the reference value previously set or less. For example, the resin in the uncured region is irradiated with light to be cured. This ends the curing process of the resin in the step S104.

Here, the curing process of the resin in the step S104 may include exposing the entire resin to light between the second curing process and the process of separating the mold from the resin of the step S105. This cures surely a portion of the resin lack of curing such as a space between the plurality of regions and a periphery of the substrate.

In this way, in the pattern formation method according to the first embodiment, the resin is cured in ascending order of positional displacement amount between the underlying pattern and the concave/convex pattern. Thereby, the pattern is formed, where the position alignment with the mold is performed with a high accuracy over the entire substrate.

For example, in the case where a plurality of first alignment marks are provided on the substrate and a plurality of second alignment marks corresponding to the plurality of first alignment marks are provided on the mold, if the mold is aligned as reference to the substrate, parts of the alignment marks are aligned, however some alignment marks are not aligned. When curing the entire resin in this state, the pattern could not be formed with excellent alignment accuracy in a periphery of the alignment marks not fully aligned.

In the embodiment, the resin is cured for every region in a state where the position alignment is performed for each of the plurality of regions. That is, even after the resin is cured for one uncured region, the position alignment is possible for other uncured region. Therefore, since the position alignment and the resin curing are performed for every region, the position alignment with high accuracy is performed for each region of the plurality of first alignment marks and the plurality of second alignment marks.

Next, the specific example (I) will be described.

FIG. 3 is a schematic plan view illustrating a specific example (I).

FIGS. 4A to 4D are schematic cross-sectional views illustrating the pattern formation method the specific example (I).

In a mold 1A shown in FIG. 3, concave/convex patterns for a plurality of shots are provided in one mold 1A. For example, concave/convex patters are provided in the mold 1A corresponding to four shot regions ST1 to ST4 in total in 2×2 arrangement.

A plurality of first alignment marks AM1 are provided on a substrate S corresponding to respective shot regions ST1 to ST4, respectively. The plurality of first alignment marks AM1 are disposed at periphery portions of each of respective shot regions ST1 to ST4.

A plurality of second alignment marks AM2 corresponding to the plurality of first alignment marks AM1 of the substrate S are provided in respective shot regions ST1 to ST4 of the mold 1A.

In order to align the mold 1A with the substrate S, the periphery of the mold 1A is pushed by an actuator not shown. The balance of the pushing aligns each of the plurality of second alignment marks AM2 with each of the plurality of first alignment marks AM1.

The specific pattern formation method will be described along FIGS. 4A to 4D.

First, as shown in FIG. 4A, a resin 50 is applied onto a first surface S1 of the substrate S. For convenience of the description, in the specific example, first alignment marks AM1a to AM1e are illustratively provided on the substrate S. Next, the mold 1A is superimposed on the substrate S, and the concave/convex pattern of the mold 1A is caused to contact the resin 50. For convenience of the description, in the specific example, second alignment marks AM2a to AM2e are illustratively provided on the mold 1A.

In the description described below, when collectively naming, a plurality of first alignment marks are referred to as the first alignment mark AM1. A plurality of second alignment marks are referred to as the second alignment mark AM2.

First, as shown in FIG. 4A, the position alignment of the mold 1A is performed using the substrate S as a reference. Next, the resin 50 is divided into a plurality of regions R1 to R5. As viewed in the Z-direction, the resin 50 is divided into the regions R1 to R5 by taking a set of the first alignment mark AM1 and the second alignment mark AM2 being at the center.

Next, for respective regions R1 to R5, the amount of positional displacement of the second alignment mark AM2 by reference to the first alignment mark AM1 is determined. For example, in the region R1, the amount of positional displacement of the second alignment mark AM2a by reference to the first alignment mark AM1a is determined, and in the region R2, the amount of positional displacement of the second alignment mark AM2b by reference to the first alignment mark AM1b is determined.

While the amounts of positional displacement are determined for respective regions R1 to R5, the regions having the amount of positional displacement not more than a reference value are selected. Here, the case where the regions R1 to R5 are selected is illustratively described. The region with the smallest amount of positional displacement out of the regions R1 to R5 to be selected is selected. In the specific example, the amount of positional displacement in the region R3 is assumed to be smallest among the regions R1 to R5.

Next, as shown in FIG. 4B, the resin 50 in the selected region is cured. Here, the region R3 is selected and then the resin in the region R3 is cured. For example, the resin 50 in the region R3 is irradiated with light LT of a wavelength (for example, ultraviolet ray) curing locally the resin 50 in the region R3. This causes only the resin 50 in the region R3 to be cured.

Next, as shown in FIG. 4C, the position alignment of the mold 1A is performed with reference to the substrate S. In this alignment, since the resin 50 in the region R3 is cured, the positional relationship between the first alignment mark AM1c and the second alignment mark AM2c does not change in the region R3. The position alignment is performed in the regions R1, R2, R4 and R5 as uncured regions.

Next, for the uncured regions (region R1, R2, R4 and R5), the amount of positional displacement of the second alignment mark AM2 by reference to the first alignment mark AM1 is determined. While the amounts of positional displacement are determined for respective regions R1 to R5, among the regions adjacent to the cured region (region R3), the regions having the amount of positional displacement not more than a reference value are selected. Here, the case where the regions R2 and R4 adjacent to the cured region R3 are selected is illustratively described. The region with the smallest amount of positional displacement of the regions R2 and R4 to be selected is selected. In the specific example, the amount of positional displacement in the region R2 is assumed to be smallest among the regions R2 and R4.

Next, the resin 50 in the selected region is cured. Here, the region R2 is selected and then the resin in the region R2 is cured. For example, the resin 50 in the region R2 is irradiated with the light LT curing locally the resin 50 in the region R2. This causes only the resin 50 in the region R2 to be cured.

The process like this is repeated until the number of uncured region is one. When the number of the uncured region is one, the position alignment of the second alignment mark AM2 is performed with reference to the first alignment mark AM1 for the uncured region. After that, the resin 50 in the uncured region is cured. This finishes curing of the resin 50 in all regions R1 to R5 as shown in FIG. 4D.

After the resin 50 in all regions R1 to R5 is cured, the entirety of the resin 50 is favorably irradiated with the light LT. When the resin 50 is cured individually for each of the regions R1 to R5, in portions such as gap among the regions R1 to R5 and edges, the resin may be uncured completely. If the entirety of the resin 50 is irradiated with the light, portions where curing is not complete is cured surely.

After the resin 50 is cured, the mold 1A is separated from the resin 50. This causes the shape of concave/convex pattern of the mold 1A to be transferred to the resin 50. In the specific example (I), the pattern is formed in a state where the position alignment with a high accuracy is performed between the mold 1A and the substrate S. So-called multishots are performed to the mold 1A.

FIGS. 5A to 5E are schematic plan views illustrating the specific example (II).

In a mold 1B shown in FIGS. 5A to 5E, a concave/convex pattern corresponding to one shot is provided in one mold 1B. As shown in FIG. 5A, for example, the concave/convex pattern is provided in one mold 1B in correspondence to one shot region ST11.

The plurality of first alignment marks AM1 are provided in the substrate S in correspondence to the shot region ST11. For example, the plurality of first alignment marks AM1 are provided at a corner and along each side of the shot region ST11. In the example shown in FIG. 5A, a plurality of first alignment marks AM1a to AM1j are illustratively provided.

A plurality of second alignment marks AM2a to AM2j corresponding to the plurality of first alignment marks AM1a to AM1j of the substrate are provided on the mold 1B.

In order to form the pattern, first, as shown in FIG. 5B, the resin is applied on the substrate S, the mold 1B is superimposed on the substrate S and the concave/convex pattern of the mold 1B is caused to contact the resin 50. Next, the position alignment of the mold 1B is performed with reference to the substrate S.

Next, the amounts of positional displacement of each of the plurality of second alignment marks AM2 by reference to each of the plurality of the first alignment marks AM1 are determined. The set of the first alignment marks AM1 and the second alignment marks AM2 having the amount of positional displacement not more than a predetermined value among the above determined amounts of positional displacement is selected.

The set of the smallest amount of positional displacement out of the sets to be selected is selected. Here, for example, the set of the first alignment mark AM1b and the second alignment mark AM2b is illustratively selected. Next, the selected set of the alignment marks is positioned at the center of the region R2 of a part of the resin 50, and the region R2 is irradiated with the light LT. The resin of the region R2 is cured.

Next, as shown in FIGS. 5C and 5D, the position alignment of the mold 1B is performed with reference to the substrate S. In this alignment, since the resin 50 in the region R2 is cured, the positional relationship between the first alignment mark AM1b and the second alignment mark AM2b does not change in the region R2. The position alignment is performed between the first alignment marks AM1 and the second alignment mark AM2 in the uncured regions other than the region R2.

Next, for the uncured region other than the cured region R2, the amount of positional displacement of the second alignment mark AM2 by reference to the first alignment mark AM1. The set of the first alignment marks AM1 and the second alignment marks AM2 having the amount of positional displacement not more than a predetermined value among the above determined amounts of positional displacement is selected.

In the specific example, the set of the first alignment mark AM1a and the second alignment mark AM2a and the set of the first alignment mark AM1c and the second alignment mark AM2c are assumed to be selected.

Next, the set of selected alignment marks is positioned at the center of a region of a part of the resin 50, and the part of the resin is cured. Here, as shown in FIG. 5E, the set of the selected first alignment mark AM1a and the second alignment mark AM2a is positioned at the center of the region R1 of a part of the resin 50, and the set of the first alignment mark AM1c and the second alignment mark AM2c is positioned at the center of the region R3 of a part of the resin 50. The region R1 and the region R3 are irradiated with the light LT, and the resin 50 in the region R1 and the region R3 is cured. An order of curing the resin in the region R1 and the region R3 may be simultaneous or one of curing may be performed precedently. This causes the resins 50 in the region R1 and R3 to be cured.

The process like this is repeated for all sets of the alignment marks. After that, the entirety of the resin 50 is irradiated with the light LT. That is, in curing of a part of the resin 50 where the set of respective alignment marks is positioned at the center, uncured portion is left. Therefore, after a part of the resin 50 where all sets of the alignment marks are positioned at the center is cured, the entirety of the resin 50 is irradiated with the light LT and the uncured resin 50 is cured.

After the resin 50 is cured, the mold 1B is separated from the resin 50. This causes the shape of concave/convex pattern of the mold 1B to be transferred to the resin 50. In the specific example (II), the pattern is formed in a state where the position alignment with a high accuracy is performed between the mold 1B and the substrate S within one shot.

### Second Embodiment

Next, a pattern formation method according to a second embodiment will be described.

FIG. 6 and FIG. 7 are flow charts illustrating the pattern formation method according to the second embodiment.

FIG. 6 shows the whole flow of the pattern formation method according to the second embodiment, and FIG. 6 shows the flow of a part of processes shown in FIG. 6.

As shown in FIG. 6, the pattern formation method according to the second embodiment includes a process of preparing a substrate (step S201), a process of applying a resin (step S202), a process of contacting the mold to the resin (step S203), a process of curing the resin (step S204), and a process of detaching the mold from the resin (step S205). The whole flow of the pattern formation method according to the second embodiment is the same as the pattern formation according to the first embodiment. In the pattern formation method according to the second embodiment, the process of curing the resin shown in the step S204 is different from the pattern formation according to the first embodiment.

Next, the process of curing the resin shown in the step S204 will be described along the flow chart of FIG. 7.

As shown in FIG. 7, first, in the step S241, for a reference region being one of a plurality of regions, the position alignment of the mold by reference to the substrate is performed. Next, in the step S242, the resin in the reference region is cured. That is, only the resin of the reference region being a part of regions of the whole resin is cured.

Next, in the step S243, it is determined whether or not there exist uncured regions. When there exist uncured regions, the processes of the steps S244 to S245 are repeated. When there exist no uncured regions, the process ends.

There exist uncured regions, first, as shown in the step S244, the position alignment of the mold is performed with reference to the substrate for the uncured regions. Here, objects to be subjected to the position alignment are uncured regions adjacent to the cured regions. Next, as shown in the step S245, the resins in the uncured regions are cured. The processes of the step S244 and the step 245 are repeated until the uncured regions diminish.

In this way, in the pattern formation method according to the second embodiment, for the plurality of regions of resin, the resins in the uncured regions adjacent to the cured regions as starting from the reference region is sequentially cured. Thereby, interposing the uncured region between two cured regions does not occur. When there exists the uncured region between two cured regions, it is uneasy to perform the position alignment between the substrate and the mold for the uncured region. In the second embodiment, interposing the uncured region between two cured regions does not occur, and thus the position alignment between the substrate and the mold is performed with a high accuracy for the whole resin.

Next, a specific example will be described.

FIGS. 8A to 8E are schematic plan views illustrating the specific example (III).

The molds 1C shown in FIGS. 8A to 8E are molds for collectively forming the pattern for the entirety of one substrate S. As shown in FIG. 8A, the substrate S is, for example, a wafer W. The plurality of first alignment marks AM1 are provided on the substrate S. The plurality of first alignment marks AM1 are provided, for example, at the center of the wafer W and along outer edge of the wafer. In the example shown in FIG. 8A, the plurality of first alignment marks AM1a to AM1i are illustratively provided.

The plurality of second alignment marks AM2a to AM2i corresponding to the plurality of first alignment marks AM1a to AM1i of the substrate S are provided on the mold 1C.

In order to form the pattern, first, as shown in FIG. 8A, the resin 50 is applied on the substrate S, the mold 1C is superimposed on the substrate S and the concave/convex pattern of the mold 1C is caused to contact the resin 50. Next, the position alignment of the mold 1C is performed with reference to the substrate S. In the specific example, the region R1 of the resin 50 where the first alignment mark AM1a and the second alignment mark AM2a are provided at the center of the wafer W is illustratively the reference region RR.

Next, as shown in FIG. 8B, for the region R1 as the reference region RR, at the stage of completing the position alignment of the second alignment mark AM2a by reference to the first alignment mark AM1a, the resin 50 in the region R1 is cured. That is, the region R1 is irradiated with the light LT and the resin in the region R1 is cured.

Next, as shown in FIG. 8C, one of the regions R2 to R9 adjacent to the region R1 where the resin 50 is cured is selected, and the position alignment is performed of the mold 1C with reference to the substrate S. In this specific example, the position alignment of the second alignment mark AM2b is performed for the region R2 adjacent to the region R1 by reference to the first alignment mark AM1b.

As shown in FIG. 8D and 8E, when the position alignment of the second alignment mark AM2b by reference to the first alignment mark AM1b is completed, the resin 50 in the region R2 is cured. That is, the region R2 is irradiated with the light LT, and the resin 50 in the region R2 is cured.

In this way, the position alignment of the second alignment mark AM2 by reference to the first alignment mark AM1 is performed sequentially for the uncured region adjacent to the region where the resin is cured (cured region), and the curing process curing the resin 50 is repeated for the region. After that, the entirety of the resin 50 is irradiated with the light LT.

After the resin 50 is cured, the mold 1C is separated from the resin 50. This causes the shape of concave/convex pattern of the mold 1B to be transferred to the resin 50. In the specific example (III), the pattern is formed in a state where the position alignment with a high accuracy is performed between the mold 1B and the wafer W (substrate S) in the entirety of the wafer.

Next, an order of resin curing will be described.

FIGS. 9A and 9B are schematic views illustrating the order of the resin curing.

In the example shown in FIG. 9A, the region R9 of a part of the resin 50 where a set of the first alignment mark AM1a and the second alignment mark AM2a provided at the outer edge of the wafer W is positioned is illustratively the reference region RR. The resin 50 is cured in an order from the region R9 as the reference region RR, the region R8 adjacent to the region R9, the region R2 adjacent to the region R8, the region R1 adjacent to the region R2, . . . . According to this order, the region where the resin 50 is cured spreads continuously.

In the example shown in FIG. 9B, the region R2 of a part of the resin 50 where a set of the first alignment mark AM1b and the second alignment mark AM2b provided at the outer edge of the wafer is positioned is illustratively the reference region RR. The resin 50 is cured in an order from the region R2 as the reference region RR, the region R1 adjacent to the region R2, the region R3 adjacent to R2 where the resin 50 is cured . . . . According to this order, the region where the resin 50 is cured spreads continuously.

Next, an irradiation range of light will be described.

FIGS. 10A and 10B are schematic plan views illustrating irradiation area of light.

In the example shown in FIGS. 10A and 10B, the area of the light LT causing the resin 50 to be cured is line-shaped. The example shown in FIG. 10A shows the case where the pattern is formed on the wafer W. In the example, an irradiation area LTA of the light LT causing the resin 50 to be cured is rectangle-shaped. A length of a long side of the irradiation area LTA is, for example, not less than a diameter of the wafer W. When the resin 50 is cured, the irradiation area LTA of the light LT is scanned in a direction of a short side. When the position alignment between the substrate S and the mold 1C is performed, the order of the position alignment of the region can be coordinated with scanning of the irradiation area LTA of the light LT.

The example shown in FIG. 10B shows the case where the pattern is formed on the rectangular (rectangle-shaped or square) shot region ST. In the example, the irradiation area LTA of the light LT causing the resin 50 to be cured is rectangle-shaped. The length of the long side of the irradiation area LTA is, for example, not less than a length of a short side of the shot region ST. When the resin 50 is cured, the irradiation area LTA of the light LT is scanned in a direction of a short side. When the position alignment between the substrate S and the mold 1C is performed, the order of the position alignment of the region can be coordinated with scanning of the irradiation area LTA of the light LT.

The region where the resin 50 is cured spreads continuously by scanning the irradiation area LTA of the light LT.

Next, a direction in which the resin is cured will be described.

FIG. 11A to FIG. 12B are schematic plan views illustrating a direction in which the resin is cured.

FIGS. 11A and 11B show directions of the resin curing in the case where the pattern is formed on the wafer W.

FIG. 11A shows the case where the irradiation area LTA of the light LT is circular. The irradiation area LTA of the light LT moves from the center of the wafer W toward the periphery. When one irradiation area LTA is irradiated with the light LT in one irradiation, the irradiation area LTA may be moved helically from the center of the wafer W toward the periphery. When a plurality of irradiation areas LTA are simultaneously irradiated with the light LT in one irradiation, the number of the irradiation areas irradiated with the light LT may be increased from the center of the wafer W toward the periphery.

FIG. 11B shows the case where the irradiation area LTA of the light LT spreads. In the example shown in FIG. 11B, the irradiation area LTA of the light LT is circular. The area where the resin 50 is cured spreads by increasing a diameter of the irradiation area LTA of the light LT. When the resin 50 at the center or the wafer W is cured, the irradiation area with a small diameter is irradiated with the light LT, and when the resin 50 at the periphery of the wafer is cured, the irradiation range with a large diameter is irradiated with the light LT.

FIGS. 12A and 12B show directions of the resin curing in the case where the pattern is formed on the rectangular shot region ST.

FIG. 12A shows the case where the irradiation area LTA of the light LT is rectangle (for example, rectangle-shaped). The irradiation area LTA of the light LT is scanned from the center of the shot region ST toward outside.

FIG. 12B shows the case where the irradiation area LTA of the light LT spreads. In the example shown in FIG. 12B, the irradiation area LTA of the light LT is rectangle (for example, rectangle-shaped). A length of a long side of the irradiation area LTA of the light LT is, for example, not less than a length of a short side of the shot region. The area where the resin 50 is cured spreads by increasing (increasing a width) a length of a short side of the irradiation area LTA of the light LT. When the resin 50 at the center of the shot region ST is cured, the irradiation area LTA with a small width is irradiated with the light LT, and when the resin 50 at an outer portion of the shot region is cured, the irradiation area LTA with a broad width is irradiated with the light LT.

In the examples shown in FIG. 11A and FIG. 12A, when the position alignment between the substrate S and the mold 1, an order of the position alignment of the regions can be coordinated with the moving direction of the irradiation area LTA of the light LT. In the examples shown in FIG. 11B and FIG. 12B, when the position alignment between the substrate S and the mold 1, an order of the position alignment of the regions can be coordinated with the spreading direction of the irradiation are LTA of the light LT. Thereby, the region where the resin 50 is cured spreads continuously in an order of the performed position alignment between the substrate S and the mold 1. Consequently, the position alignment with a high accuracy between the substrate S (wafer W) and the mold 1 is performed over the entirety of the substrate S, and the pattern with a suppressed positional displacement is formed.

### Third Embodiment

FIG. 13 is a schematic view illustrating the configuration of a pattern formation apparatus according to a third embodiment.

As shown in FIG. 13, a pattern formation device 110 includes a mold holder 2, a substrate holder 5, an alignment unit 9, an applying unit 14, a drive unit 8, a light emitting unit 12, and a control unit 21. The pattern formation device 110 further includes an alignment sensor 7 and a pressure unit 10. The pattern formation device 110 according to the embodiment is an imprint device configured to transfer the shape of the concave-convex pattern of the mold 100 to the resin on the substrate S.

The substrate is, for example, a semiconductor substrate and a glass substrate. An underlying pattern is formed on the substrate S. The substrate S may include a film formed on the underlying pattern. The film is at least one of an insulating film, a metal film (conductive film) and a semiconductor film. A resin is applied onto the substrate S when transferring.

The substrate holder 5 is provided on a stage platen 13 to be movable. The substrate holder 5 is provided to be movable along each of two axes along an upper surface 13a on the stage platen 13. Here, the two axes along the upper surface 13a of the stage platen 13 are taken as an X-axis and a Y-axis. The substrate holder 5 is provided to be movable also along a Z-axis orthogonal to the X-axis and the Y-axis. It is desired that the substrate holder 5 is provided to be rotatable around each of the X-axis, the Y-axis and the Z-axis.

The substrate holder 5 is provided with a reference mark stage 6. A reference mark (not shown) serving as a reference position of the device is placed the reference mark stage 6. The reference mark is constituted from, for example, a diffraction lattice. The reference mark is used for calibration of the alignment sensor 7 and positioning (attitude control/adjustment) of the mold 1. The reference mark is an original point on the substrate holder 5. An X-Y coordinate of the substrate S placed on the substrate holder 5 serves as a coordinate having the reference mark stage 6 as the original point.

The mold holder 2 fixes the mold 1. The mold holder 2 holds an outer portion of the mold 1 by, for example, vacuum chuck. Here, the mold 1 is formed from materials transmissive to a ultra-violet ray such as quartz or fluoric. A transfer pattern made of concave-convex formed on the mold 1 includes a pattern corresponding to a device pattern and a pattern corresponding to the alignment mark used for positioning the mold 100 and the substrate S. The mold holder 2 operates so as to position the mold 1 to a device reference. The mold holder 2 is attached to a base unit 11.

The alignment unit 9 and the pressure unit 10 (actuator) are attached to the base unit 11. The alignment unit 9 is equipped with adjustment mechanism fine-tuning the position (attitude) of the mold 1. The alignment unit 9 corrects a relative position between the mold 1 and the substrate S by fine-tuning the position (attitude) of the mold 1. The alignment unit 9 takes directions, for example, from the control unit 21 to position the substrate S and the mold 100 and to fine-tune the position of the mold 1.

The pressure unit 10 applies a stress to a side surface of the mold 1 to twist the mold 1 out of shape. In the case of the rectangular mold 1, the pressure unit 10 pressures the mold 1 from four side surfaces of the mold 1 toward the center. Thereby, a size of the transferred pattern corrects (magnification correction). The balance pushing the mold 1 causes the pressure unit 10 to deform the mold 1. The pressure unit 10 takes directions from, for example, from the control unit 21 to pressure the mold 1 by a prescribed pressure.

The alignment sensor 7 detects a second alignment mark AM2 provided on the mold 1 and a first alignment mark AM1 provided on the substrate S. The alignment sensor 7 includes, for example, an optical camera. An amount of relative positional displacement between the first alignment mark AM1 and the second alignment mark AM2 is determined from an image signal taken in by the optical camera.

The alignment sensor 7 uses light of a wavelength different from a wavelength of light emitted from the light emitting unit 12 and causing the resin 50 to be cured when scanning images of the first alignment mark AM1 and the second alignment mark AM2.

The alignment sensor 7 detects the positional displacement of the mold 1 to the reference mark on the reference mark stage 6 and the positional displacement of the mold 1 referenced to the substrate S. The positions (for example, X-Y coordinate) of the first alignment mark AM1 and the second alignment mark AM2 detected by the alignment sensor 7 are sent to the control unit 21. The alignment sensor 7 may be either fixed type or movable type.

The control unit 21 operates the displacement amount based on position information of the first alignment mark AM1 and the second alignment mark Am2 detected by the alignment sensor 7. The alignment unit 9 adjusts alignment of the substrate S and the mold 1 based on the signal sent from the control unit 21.

The control unit 21 controls a light emitting unit 12. In forming the pattern by the imprint method, after applying the resin 50 on the substrate S, the resin is irradiated with light from the light emitting unit 12 in a state where the concave-convex pattern of the mold 1 is in contact with the resin 50. The control unit 21 controls irradiation timing and irradiance level of the light.

The light emitting unit 12 emits, for example, a ultra-violet ray. The light emitting unit 12 is placed, for example, directly on the mold 1. The position of the light emitting unit 12 is not limited to directly on the mold 1. In the case where the light emitting unit 12 is disposed at a position other than directly on the mold 1, it is only necessary to configure to set an optical path using an optical member such as a mirror etc. to emit the light emitted from the light emitting unit 12 from directly on the mold 1 toward the mold 1.

The applying unit 14 applies the resin onto the substrate S. The applying unit 14 includes a nozzle, and drops the resin onto the substrate S from the nozzle.

The drive unit 8 drives the mold holder 2 and the substrate holder 5. The rive unit 8 drives at least one of the mold holder 2 and the substrate holder 5 to change the relative positional relationship between the mold 1 and the substrate S.

The control unit 21 of the pattern formation device 110 controls the light LT emitted from the light emitting unit 12 and exposed to the resin 50 in a state where the concave-convex pattern of the mold 1 is in contact with the resin 50 divided into a plurality. The control unit 21 controls the light emitting unit 12 so that an uncured region where the resin 50 in the plurality of regions is uncured is irradiated with the light LT. The control unit 21 controls the drive unit 8 so as to separate the mold 1 from the resin 50 after curing of the resin 50 in the plurality of regions.

The light emitting unit 12 of the pattern formation device 110 has the configuration where the plurality of regions of the resin 50 are irradiated with the light LT individually. For example, the light emitting unit 12 has a mechanism that the light emitted from the light emitting unit is exposed to the plurality of irradiation areas and a mechanism that the irradiation areas of the light are moved. The control unit 21 controls the light emitting unit 12 to determine which position of the plurality of regions of the resin 50 is irradiated with the light, how much amount of light is exposed, and timing of the irradiation or the like.

The pattern formation device 110 forms the pattern by the pattern formation methods according to the first and second embodiments described above. That is, in the pattern formation method according to the first embodiment, the control unit 21 of the pattern formation device 110 executes the processes of the step S141 to the step S146 shown in FIG. 2. In the pattern formation method according to the second embodiment, the control unit 21 of the pattern formation device 110 executes the processes of the step S241 to the step S245 shown in FIG. 7.

According to the pattern formation device 110, the pattern formation with the position alignment of the mold 1 is performed on the entirety of the substrate with a high accuracy.

### Fourth Embodiment

The pattern formation methods according to the first and second embodiments described above is feasible as a program (alignment program) executed by a computer.

FIG. 14 illustrates the hard ware configuration of a computer.

A computer 200 includes a central processing unit 201, an input unit 202, an output unit 203, and a memory unit 204. The input unit 202 includes a function to read out information recorded in a record medium M. The alignment program is executed by the central processing unit 201.

The alignment program makes the computer 200 execute the processes of the step S141 to step S146 shown in FIG. 2. The alignment program makes the computer 200 execute the processes of the step S241 to step S245 shown in FIG. 7.

The alignment program may be recorded in the record medium capable of being read out by a computer. The record medium M stores the processes of the step S141 to the step S146 shown in FIG. 2 in a scheme in which the processes can be read out by the computer 200. The record medium M may store the processes of the step S241 to the step S245 shown in FIG. 7 in a scheme in which the processes can be read out by the computer 200. The record medium M may be a memory device such as a server connected to the network. The pattern formation program may be distributed via the network.

As described above, according to the pattern formation method and the pattern formation device according to the embodiments, the accuracy of the position alignment between the mold and the substrate is improved.

Although the embodiment and modifications thereof are described above, the invention is not limited to these examples. For example, additions, deletions, or design modifications of components or appropriate combinations of the features of the embodiments appropriately made by one skilled in the art in regard to the embodiments or the modifications thereof described above are within the scope of the invention to the extent that the purport of the invention is included.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A pattern formation method comprising:
preparing a substrate having an underlying pattern and applying a resin to the substrate;
preparing a mold having a concave/convex pattern, interposing the mold on the substrate, and causing the concave/convex pattern to contact the resin;
curing the resin in an uncured region where the resin is uncured, the uncured region being one of a plurality of regions into which the resin is divided; and
separating the mold from the resin,
the curing the resin in the uncured region including:
a first curing process; and
a second curing process,
when the uncured region is provided in a plurality,
the first curing process including:
performing position alignment of the mold with reference to the substrate;
determining a positional displacement amount of the concave/convex pattern with reference to the underlying pattern for each of the plurality of uncured regions; and
curing the resin in the uncured region having a smallest positional displacement amount in the plurality of uncured regions,
the performing, the determining and the curing being repeated until the uncured regions are reduced to one;
when the uncured region is one,
the second curing process including:
performing position alignment of the mold with reference to the substrate; and
curing the resin in the uncured region.

2. The method according to claim 1, wherein the curing the resin in the uncured region includes curing the resin by exposing the resin to a light.

3. The method according to claim 2, wherein the curing the resin in the uncured region further includes exposing an entirety of the resin to the light between the second process and the separating the mold from the resin.

4. The method according to claim 1, wherein
the underlying pattern includes a first alignment mark, and
the concave/convex pattern includes a second alignment mark.

5. The method according to claim 1, wherein the curing the resin in the uncured region includes curing the resin when the positional displacement amount is not more than a predetermined reference value in the uncured region.

6. The method according to claim 1, wherein in the first curing process, the curing the resin in the uncured region having the smallest positional displacement amount, when there exists a cured region where the resin is cured out of the plurality of regions, includes causing the uncured region adjacent to the cured region out of the plurality of the regions to be an object of the resin to be cured.

7. A pattern formation device comprising:
a mold holder holding a mold having a concave/convex pattern;
a substrate holder holding a substrate;
an alignment unit configured to perform position alignment between the substrate and the mold;
an applying unit configured to apply a resin on the substrate;
a drive unit configured to drive the mold holder and the substrate holder;
a light emitting unit configured to emit a light exposed to the resin; and
a control unit configured to control the light emitting unit so that the resin is divided into a plurality of regions and an uncured region of the plurality of regions is exposed to the light, the resin being uncured in the uncured region, when the resin is exposed to the light in a state of the concave/convex pattern contacting the resin, and configured to control the drive unit so separate the mold from the resin after the resin in the plurality of regions being cured,
the control unit performing a first process,
when the uncured region is provided in a plurality,
the first process including:
controlling the alignment unit so as to perform position alignment of the mold with reference to the substrate;
operating a positional displacement amount of the concave/convex pattern by reference to the underlying pattern for each of the plurality of uncured regions; and
controlling the control unit so as to cure the resin by exposing the resin in the uncured region having a smallest positional displacement amount out of the plurality of the uncured regions to the light,
until the uncured regions are reduced to one,
the control unit performing a second process,
when the uncured region is one,
the second process including:
controlling the alignment unit so as to perform position alignment of the mold with reference to the substrate; and
controlling the light emitting unit so as to curing the resin by exposing the resin in the uncured region to the light.

8. The device according to claim 7, wherein the control unit controls the light emitting unit so as to expose an entirety of the resin to the light after curing the resin in the uncured region and before separating the mold from the resin.

9. The device according to claim 7, wherein
the underlying pattern includes a first alignment mark, and
the concave/convex pattern includes a second alignment mark.

10. The device according to claim 7, wherein the control unit controls the light emitting unit so as to expose the uncured region to the light, when the positional displacement amount is not more than a predetermined reference value.

11. The device according to claim 7, wherein in the first curing process, the process curing the resin in the uncured region having the smallest positional displacement amount, when there exists a cured region where the resin is cured out of the plurality of regions, includes curing the resin in the uncured region adjacent to the cured region out of the plurality of uncured regions.

12. A pattern formation device comprising:
a mold holder holding a mold having a concave/convex pattern;
a substrate holder holding a substrate;
an alignment unit configured to perform position alignment between the substrate and the mold;
an applying unit configured to apply a resin on the substrate;
a drive unit configured to drive the mold holder and the substrate holder;
a light emitting unit configured to emit a light exposed to the resin; and
a control unit controlling the light emitting unit and the drive unit in a state of the concave/convex pattern contacting the resin, the light emitting unit being controlled emitting the light to a plurality of regions, the plurality of regions being divided the resin, the drive unit being controlled separating the mold from the resin after the resin in the plurality of regions being cured,
the control unit performing
positional alignment of the mold by reference to the substrate for a reference region being one of the plurality of regions and curing the resin in the reference region, and
repeating performing positional alignment of the mold by reference to the substrate for an uncured region adjacent to a cured region where the resin is cured out of the plurality of regions, the resin being uncured in the uncured region, and curing the resin, until the uncured region is diminished.

13. The device according to claim 12, wherein the reference region is a region nearest to a center of the substrate out of the plurality of regions.

14. The device according to claim 12, wherein the reference region is one of regions nearest to an end of the substrate out of the plurality of regions.

15. The device according to claim 12, wherein the control unit controls to change an irradiation area of the light in accordance with a position where the resin is cured.

16. The device according to claim 12, wherein the control unit controls to move an irradiation position of the light in accordance with a position where the resin is cured.
